(19) United States
(12) Patent Application Publication
(10) Pub. No.: US 2016/0241601 A1
(43) Pub. Date: Aug. 18, 2016

(54) TECHNIQUE FOR RESTORING A SERVICE IN A NETWORK

(71) Applicant: ORANGE, Paris (FR)

(72) Inventors: Jean-Claude Le Rouzic, Trebeurden (FR); Jose Doree, Lannion (FR)

(21) Appl. No.: 15/025,810

(22) PCT Filed: Sep. 25, 2014
(86) PCT No.: PCT/FR2014/052406

§ 371 Date: Mar. 29, 2016

(30) Foreign Application Priority Data
Sep. 30, 2013 (FR) 1359388

(51) Int. Cl. H04L 29/06

(52) U.S. Cl. CPC H04L 65/1006; H04L 65/1016; H04L 65/1073

(57) ABSTRACT

A processing method for use in a communications network to process a service request relating to a user. During a first stage referred to as a “detection” stage an interrogation server interrogates a subscriber server in order to obtain an identifier of a nominal registration server to which it transfers the service request, and in the event of the transfer failing, it interrogates the subscriber server in order to obtain the capabilities that a registration server needs to possess in order to be capable of delivering the services authorized for the user. Once the nominal registration server is considered to be unreachable, a second stage is started, referred to as an “optimization” stage, during which a single transfer is made to registration servers of the service request relating to a user.

### CROSS-REFERENCE TO RELATED APPLICATIONS

This Application is a Section 371 National Stage Application of International Application No. PCT/FR2014/052406, filed Sep. 25, 2014, the content of which is incorporated herein by reference in its entirety, and published as WO 2015/044596 on Apr. 2, 2015, not in English.

### FIELD OF THE DISCLOSURE

The invention lies in the field of Internet protocol (IP) type communications networks, and more particularly it relates to a technique of restoring a service for a user in an IP multimedia system (IMS) type network.

### BACKGROUND OF THE DISCLOSURE

An IMS network architecture, as defined by the third generation partnership project (3GPP) standards group, enables multimedia sessions to be set up and controlled between two user equipments and also enables resources to be reserved for the multimedia streams in the transport network. By means of this architecture, network operators can conveniently control the quality of service they offer. At present, IMS architecture makes it possible to offer telephone, videophone, presence, and instant messaging type services and it also manages interactions between these services. In general, it makes use of session initiation protocol (SIP) as defined by the Internet engineering task force (IETF) in Document RFC 3261 as the protocol for managing sessions, thus making it possible to set up, modify, and terminate multimedia sessions in a network using IP protocol.

Such an IMS network architecture comprises in particular:
one or more home subscriber servers (HSSs) each having a user database. Each subscriber server contains the “profile” of some number of user equipments in the network, where the profile contains the registration status, authentication and location data, and the services to which those pieces of equipments have subscribed;
one or more registration servers known as serving-call server control function (S-CSCF) servers serving in particular to manage the procedure of registering user equipments connected to the network;
one or more interrogation servers referred to as interrogating-call server control function (I-CSCF) servers serving to interrogate a subscriber server when registering user equipment in order to obtain an identifier of a registration server having the requisite characteristics for reaching the level of service to which the user has subscribed, where such a server is referred to below as the “nominal registration server”; and
one or more proxy servers known as proxy-call server control function (P-CSCF) servers serving as connection entities between the IMS core network and the access network used by the user equipments, and suitable for relaying all of the signaling messages between user equipments on one side and S-CSCF or I-CSCF servers on the other.

In order to ensure continuity of service in an IMS network, the 3GPP standards group has published a technical specification Document TS-23.380 version 11.1.0 entitled “IMS restoration procedures” defining procedures relating to restoring service within an IMS network when a nominal registration service cannot be reached (e.g. a network failure, or a failure of the registration server itself). In particular, two restoration procedures are described, the first taking place when registering user equipment with the IMS network (TS 23.380, §4.2.2), and the second taking place at the end of a session with user equipment (TS 23.830, §4.3.3). Both of those procedures provide for an I-CSCF interrogation server to send a capabilities request message to an HSS subscriber server so that the I-CSCF interrogation server can select a replacement S-CSCF registration server. These “capabilities” are defined in chapter 6.7 of the 3GPP technical specifications TS 29.228. That makes it possible to ensure continuity of service in the IMS network in a manner that is transparent to the user.

A drawback of the service restoration procedures as specified in specification document TS 23.380 is that while processing a service request relating to a user, the request is always transferred to the nominal registration server. In the event of the nominal registration server remaining unreachable, the wait for a reply from that server and the retransmissions of the service request to that nominal registration server consume a particularly large amount of network resources, even though the network capabilities are reduced, in particular as a result of the nominal registration server being unavailable. There therefore exists a need to improve the processing of a service request relating to a user while restoring service in an IMS network.

### SUMMARY

In a first aspect, the invention provides a processing method to be performed in a communications network to process a service request relating to a user, said method comprising the following steps performed by an interrogation server during an optimization stage:
a/ receiving said service request relating to a user and coming from a user equipment;
b/ interrogating the subscriber server in order to obtain information enabling the service request to be processed;
c/ receiving capabilities that a registration server needs to possess in order to be capable of delivering the services authorized for said user, the capabilities being received from a subscriber server; and
d/ determining a replacement registration server on the basis of the received capabilities, and transferring the service request to the replacement registration server as determined;
wherein, during a detection stage during which the registration server is considered to be reachable, said nominal registration server being associated with said user, and said method further comprises the following steps prior to the step c/ of receiving capabilities:
b1/ receiving an identifier of a nominal registration server in response to the interrogation of step b/;
b2/ transferring the service request to the nominal registration server; and in the event of a failure of making this transfer to the nominal registration server:
b3/ interrogating the subscriber server in order to obtain said capabilities;
and once the nominal registration server is considered to be unreachable at the end of the detection stage, starting the optimization stage, during which the transfer of step d/ is the sole transfer of the service request that is made to registration servers.

The detection stage performs the steps specified in the restoration procedures described in technical specification TS 22.380. The processing method thus provides an optimization stage that is started when the nominal registration server is considered to be unreachable. By means of this processing method, the service request relating to the user is transferred only once to a registration server during the optimization stage. It is thus possible to avoid the waiting and retransmission time required following the transfer of the service request to a registration server that is not reachable. The service restoration procedures as defined in technical specification TS 23.380 are implemented only once it has been observed that the nominal registration server is unavailable after making a first transfer of the service request to the nominal registration server. A single transfer of the service request during the optimization stage makes it possible to economize the use of network resources and to optimize the processing of service requests relating to a user in the event of a nominal registration server being unavailable. Traffic within the network is also reduced. Continuity of service is thus reinforced, thereby contributing to improving the quality of service as perceived by the user.

According to a particular characteristic, the processing method further comprises a step of determining that the nominal registration server should be considered as being unreachable, which step is performed by the interrogation server.

The step of determining that the nominal registration server should be considered as being unreachable serves to start the optimization stage. The management of service restoration is local to each interrogation server of the network. It is possible to implement service restoration strategies that are specific to each interrogation server of the network, e.g. as a function of the number of transfer failures needed to start the optimization stage.

According to another particular characteristic, the processing method comprises a step of determining that the nominal registration server should be considered as being unreachable, which step is performed by the subscriber server.

The subscriber server starting the optimization stage enables service restoration management to be centralized. The subscriber server can keep track of information about the unavailability of a registration server for each of the registration servers in the network. When the subscriber server is interrogated by an interrogation server in order to obtain an identifier for a nominal registration server associated with a user, the subscriber server returns capabilities directly in response to the interrogation on identifying the registration server as being unreachable or unavailable. This avoids any need for a second interrogation of the subscriber server by the interrogation server in order to obtain capabilities and potentially suffer a new failure to transfer the service request, thereby having the effect of reducing network traffic. It should also be observed that since the management is centralized, the number of subscriber server interrogations is independent of the number of interrogation servers in the network.

According to a particular characteristic, the unreachable status of the nominal registration server is determined using at least one counter associated with said nominal registration server that is updated during the detection stage in the event of a failure to transfer to the nominal registration server.

Using a counter makes it possible to have direct information about the number of transfer failures for a given registration server. In association with an unreachability status of a registration server, it makes it possible to define various strategies about starting the optimization stage. By way of example, this stage may be started as a function of the number of failures to transfer the service request. By way of example, an operator may decide to define a small number of transfer failures prior to starting the optimization stage for interrogation servers that require better continuity of service, and a higher number for environments that are tolerant of service interruptions. It is thus possible for the operator to propose different levels of quality of service to a user.

Since the counter is also associated with a registration server independently of the type of service request, it is simple for the counter to manage values to starting the optimization stage. Only one counter needs to be updated for each registration server known to an interrogation server.

According to a particular characteristic, the unreachable status of the nominal registration server is determined on the basis of a plurality of counters respectively associated with a plurality of types of service request.

Counters that are specialized by type of service request make it possible to implement fine management of strategies for restoring service in an IMS network. By way of example, an operator may give precedence to continuity of service for requests relating to registration (e.g. user authorization requests (UARs)) for a user equipment on the IMS network, and may adopt a different service restoration policy for location info requests (LIRs), for example.

In a second aspect, the invention provides an interrogation server arranged to process a service request relating to a user, the server comprising:
a first transceiver module arranged to receive said service request relating to a user from a user equipment and to transfer it to a registration server;
a second transceiver module arranged to interrogate a subscriber server in order to obtain in return an identifier of a registration server associated with the user or to receive capabilities that a registration server needs to possess in order to be capable of delivering the services authorized for a user;
a selector module arranged to determine a replacement registration server on the basis of the received capabilities; and
a control module arranged to cause a subscriber server to be interrogated so that, during a first stage, an identifier is obtained for a nominal registration server associated with the user, a transfer is made to the nominal registration server, and in the event of a failure to transfer the service request to said nominal registration server, capabilities are obtained; and also arranged, during a second stage, to act when the nominal registration server is considered to be unreachable so as to make a single transfer of the service request relating to a user to a registration server.

According to a particular characteristic, the interrogation server also comprises a calculation module arranged to update at least one counter relating to an unreachability status of a registration server.

The advantages set out for the processing method in accordance with any of the characteristics of the first aspect are directly transposable to the interrogation server of the second aspect.

In a third aspect, the invention provides a subscriber server arranged to process a service request relating to a user, the server comprising:
a transceiver module arranged to respond to an interrogation from an interrogation server, in particular to supply it with an identifier of a nominal registration server associated with the user or to supply it with capabilities that a registration server needs to possess in order to be able to deliver the services authorized for a user; and
a control module arranged to act during an optimization stage during which the nominal registration server is considered to be unreachable, to cause capabilities to be supplied directly in response to a request for the identifier of said nominal registration server.

According to a particular characteristic, the subscriber server further comprises a calculation module arranged to update at least one counter relating to an unreachability status of a registration server.

In a fourth aspect, the invention provides a system for processing a service request in a communications network, said system comprising:
an interrogation server of the second aspect;
a calculation module arranged to update at least one counter relating to an unreachability status of a registration server; and
a subscriber server comprising:
   a transceiver module arranged to respond to an interrogation from an interrogation server, in particular to supply it with an identifier of a registration server associated with the user or to supply it with capabilities that a registration server needs to possess in order to be capable of delivering services authorized for a user; and
   a control module arranged to make the response to the interrogation server.

According to a particular characteristic, the control module of the subscriber server is also arranged, during an optimization stage in which the nominal registration server is considered to be unreachable, to supply capabilities directly in response to a request for an identifier of said nominal registration server.

In a fifth aspect, the invention provides a program for an interrogation server comprising program code instructions for controlling the execution of steps of the above-described method when said program is executed by said server, and a data medium readable by an interrogation server containing a program for an interrogation server.

In a sixth aspect, the invention provides a program for an subscriber server comprising program code instructions for controlling the execution of steps of the above-described method when said program is executed by said server, and a data medium readable by a subscriber server containing a program for an subscriber server.

### BRIEF DESCRIPTION OF THE DRAWINGS

The invention can be better understood from the following description of particular implementations given with reference to the accompanying drawings, in which:

FIG. 1 shows a system for processing a service request relating to a user in a communications network;

FIG. 2 shows an interrogation server performing a method of processing a service request in a particular implementation;

FIG. 3 shows a subscriber server in a particular embodiment; and

FIGS. 4a and 4b show steps of a method of processing a service request relating to a user in two particular implementations.

### DETAILED DESCRIPTION OF ILLUSTRATIVE EMBODIMENTS

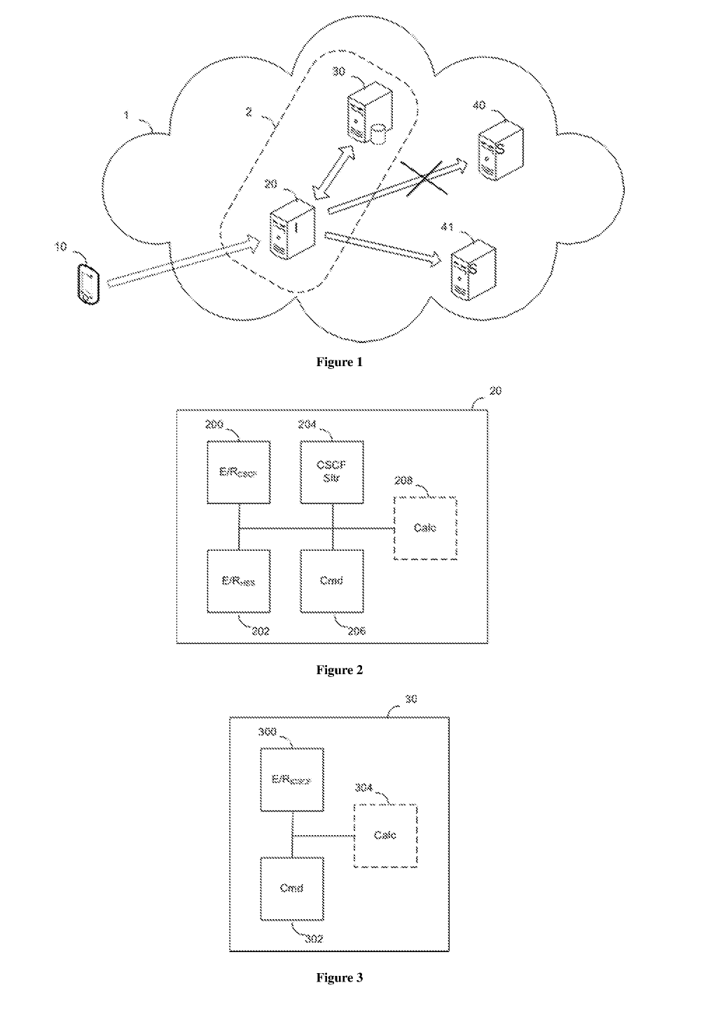

FIG. 1 shows a system 2 for processing a service request in a communications network 1. The multimedia services offered by the network 1 may comprise telephone, videophone, content sharing, presence, instant messaging, or television services. The system 2 serves to transfer a registration request from a user equipment (UE) 10 over the network 1 to a registration server and to benefit from services made available by the network.

The user equipment 10 may for example be a fixed or mobile terminal, or a home or business gateway. The system 2 comprises an interrogation server 20, a subscriber server 30, and a calculation module (not shown) serving to determine whether a registration server is reachable. By way of example, in a first embodiment described below the calculation module may be incorporated in the interrogation server 20, or else, in a second embodiment also described below, it may be incorporated in the subscriber server 30. The subscriber and interrogation servers 30 and 20 also communicate with each other. The interrogation server 30 also communicates with registration servers 40-41.

It should also be observed that FIG. 1 is shown in simplified manner in order to make it easier to understand. Nevertheless, there is no limit concerning the number of subscriber servers, of registration servers, or of interrogation servers belonging to the communications network. Likewise, there is no limit on the number of user equipments.

In the particular situation where the communications network 1 presents IMS type architecture, the interrogation server 20 is an I-CSCF server, the registration servers 40-41 are S-CSCF servers, and the subscriber server 30 is an HSS server, it being possible for some of these various servers to be combined within a single entity, when appropriate. With such an IMS architecture, the SIP signaling protocol is used for exchanges with the user equipment 10, and also between the interrogation and registration servers 20, 40-41. The exchanges between the subscriber server 30 on one side and the interrogation and registration servers 20, 40-41 on the other are conveyed by the Diameter protocol.

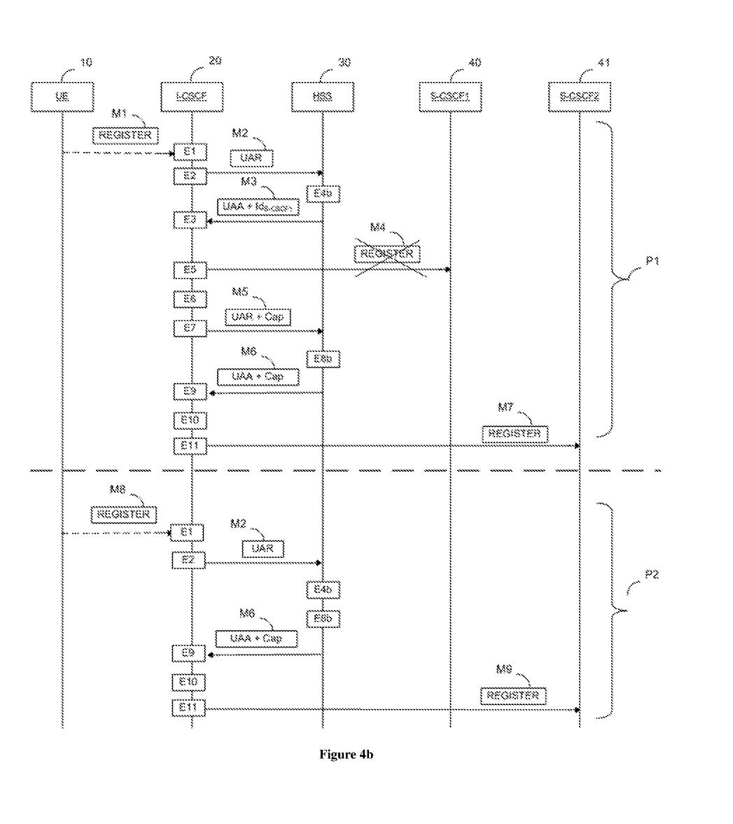

The implementations described below with reference to FIGS. 4a and 4b show a method of processing a service request relating to a user. They rely on two stages: a first stage P1 of detection and a second stage P2 of optimization. During the detection stage P1, in the event of a failure to transfer the service request relating to a user to a nominal registration server 40, the service restoration procedures as defined in the technical specification TS 23.380 are performed. Then on detecting that the registration server is not reachable, the optimization, second stage P2 is started.

FIG. 4a describes the steps of the method of processing a service request relating to a user in a first implementation.

In this first implementation, detecting that the nominal registration server 40 is not reachable is performed in the IMS communications network 1 by the interrogation server 20.

In a step E1, the interrogation server 20 receives a service request M1 relating to a user and coming from a user equipment 10. The service request M1 may for example be an SIP REGISTER request for registration with a registration server.

In a step E2, the interrogation server 20 interrogates the subscriber server 30 in order to obtain an identifier for the nominal registration server 40 that possesses the characteristics required to achieve the level of service to which the user has subscribed. This interrogation is performed more particularly by sending a user-authorization-request (UAR) message M2 in the Diameter protocol as defined in RFC 4740 and in compliance with the 3GPP specifications TS 24.229 and TS 29.228.

During a step E3, the interrogation server 20 receives a user-authorization-answer (UAA) message M3 from the subscriber server 30 in response to the UAR request M2, which UAA message specifies an identifier Id_{S-CSCF1} of the nominal registration server 40 with which the user is registered. By way of example, this identifier is a uniform resource identifier (URI) as defined by RFC 3986.

In a step E4, the interrogation server 20 uses a counter CPT to verify whether a threshold S1 has been reached for passing to a second stage P2 referred to as an “optimization” stage. The threshold S1 is defined by the operator of the communications network. Reaching this threshold S1 terminates a first stage P1 referred to as the “detection” stage, after which the nominal registration server 40 is considered to be unreachable. The second stage P2 is then started. Before the second stage P2 has been started, the interrogation server 20 acts in a step E5 to transfer the SIP REGISTER request (message M4) to the nominal registration server 40 identified in step E3.

In step E6, an absence of response to the SIP REGISTER request is observed by the interrogation server 20. The SIP protocol makes provision for mechanizing the retransmission of messages, at the end of which, after several transmission attempts without response, the absence of response is considered as being identical to a 408 Request Timeout response code, indicating that no response has been received from the nominal registration server 40 within the time allowed for processing the message. By way of example, the absence of response from the nominal registration server 40 may be the result of it suffering a failure, of disturbed network traffic, or of any other cause that prevents it being reached or that prevents it from responding to a request it has received.

In a step E7, in compliance with the IMS service restoration procedures as defined in the 3GPP technical specifications TS 23.380, a new UAR message M5 including a request for capabilities is sent to the subscriber server 30. The request for capabilities is constructed by putting the REGISTRATION AND CAPABILITIES value in the user-authorization-type field of the UAR message M5.

Thereafter, the interrogation server 20 increments the counter CPT associated with the registration server 40 in a step E8. The counter CPT is incremented each time a UAR request is transmitted including a request for capabilities during the detection stage. In the presently-described implementation, a counter is associated with each registration server. In a step E9, the interrogation server 20 receives a response from the subscriber server 30 in the form of a UAA message M6 including the requested capabilities.

The interrogation server 20 then acts during a step E10 on the basis of the received capabilities to determine a new registration server 41 capable of providing the service requested by the user equipment 10. This registration server 41 that has been determined in this way, referred to as the replacement registration server, thus takes the place of the nominal registration server 40 with which an attempt at transferring a SIP REGISTER request has previously failed.

In a step E11, the interrogation server 20 transfers the SIP REGISTER request M7 to the registration server 41 as determined in step E10.

Steps E1 to E11 are performed once more each time a service request is received relating to a user so long as the detection stage has not come to an end. I.e., so long as the counter associated with the registration server 40, as incremented in step E8, does not exceed the threshold S1.

When the threshold S1 is reached, the nominal registration server 40 is considered to be unreachable and the optimization second stage P2 is triggered. This second stage P2 differs from the first stage P1 by the absence of steps E5 and E6. Only steps E1 to E4 and E7 to E11 are performed for processing a service request relating to a user.

During this second stage P2, the interrogation server 20 uses the counter CPT associated with the nominal registration server 40 to verify whether the threshold S1 has been reached for passing to the optimization second stage P2. Reaching this threshold S1 brings the detection first stage P1 to an end, at the end of which the nominal registration server 40 is considered to be unreachable. Transfer of the service request relating to a user to the nominal registration server 40 is then inhibited during the optimization stage.

Steps E7 to E11 are then performed as described above with reference to the first stage P1 in order to transfer the service request relating to a user to the replacement registration server 41. A single service request transfer is thus performed during the second stage P2. The method advantageously makes it possible to avoid the waiting time and the retransmissions generated (during step E5) by the absence of response from the nominal registration server 40. This makes it possible in particular to optimize the use of the resources of the network.

In a particular implementation, the interrogation server 20 continues during the second stage P2 to increment that counter CPT associated with the nominal registration server 40 during a step E8. During this second stage P2, this step makes it possible, by way of example, to define a second threshold S2 associated with the nominal registration server 40 that, on being exceeded, makes it possible to return to nominal processing of the service request. This second threshold makes it possible, by way of example, to detect that a certain number of UAR requests including a request for capabilities have been sent. It is then probable that the nominal registration server 40 is once more in operation, e.g. if it had suffered a failure.

The steps E1 to E4 and E7 to D11 of this second stage P2 are performed once more on each occasion a service request is received relating to a user, e.g. until the second threshold S2 is reached enabling a return to nominal processing of service requests relating to a user or enabling the network operator to take action to replace the nominal registration server, thereby terminating the second stage P2.

In another implementation, on reaching the second threshold S2, the interrogation server (20) transfers the service request relating to the user to the nominal registration server (40). In the event that this nominal registration server is reachable once again, the counter CPT is reset to zero, thus enabling service requests to return to nominal processing. By way of example, the nominal registration server (40) remains unreachable, a new attempt is made to transfer the service request relating to the user to that server may be performed on reaching a new threshold value Sₙ that is a function of the threshold S2. By way of non-limiting example, a transfer attempt may be made for each threshold value Sₙ=2ⁿ×S2.

FIG. 4b describes the steps of the method of processing a service request relating to a user in a second implementation.

In this second implementation, detection that the nominal registration server 40 cannot be reached is performed in the IMS communications network 1 by the subscriber server 30.

In this second implementation, the counter associated with the nominal registration server 40 is no longer managed by the interrogation server 20, but rather by the subscriber server 30. The subscriber server 30, and more precisely the calculation module, then performs a step E8b that is similar to step E8. The counter associated with the nominal registration server 40 is then incremented by the subscriber server 30 each time a UAR message M5 is received that includes a request for capabilities. Likewise, the determination that the nominal registration server 40 is to be considered as being unreachable, thus enabling the second stage P2 to be performed, is undertaken by the subscriber server 30 during a step E4b, similar to the step E4. In this second implementation, during the second stage P2, the interrogation server 20 performs the steps E1 and E2 as described above with reference to the first implementation and it transmits a nominal UAR request M2. On receiving this nominal UAR request, the subscriber server 30 responds in the second stage P2 directly with a UAA message containing capabilities as received by the interrogation server 20 in the step E9. The subscriber server 30 thus responds as though it had received a UAR request including a request for capabilities from the interrogation server 20. In this second implementation, the interrogation server 20 is thus arranged to receive capability information without previously requesting it.

It is emphasized at this point that, since the steps E3 to E7 described above with reference to FIG. 4a are not performed in this second implementation during the second stage P2, the processing method serves to avoid exchanging the UAR message (step E7) and the UAA message (step E3) between the interrogation server 20 and the subscriber server 30. Sending an SIP REGISTER request to the nominal registration server 40 is also avoided (step E5). This makes it possible in particular to optimize the use of the resources of the network, most particularly by reducing signaling message traffic due to the redundancy of the UAR and UAA messages.

Steps E10 and E1 are then performed in the manner described above with reference to FIG. 4a.

The management of the counter used for determining whether a registration server is unreachable is centralized in the subscriber server 30, and as a result it is likewise easier to implement. This second implementation makes it possible in particular for the subscriber server 30 to respond to an interrogation server for a service request relating to the user without the interrogation server needing to request capabilities explicitly.

This second implementation also makes it possible for the advantages of performing the processing method to benefit an interrogation server receiving a service request relating to the user and presenting, by way of example, little traffic, given that account is taken of UAR messages received from other interrogation servers during the step E8b of updating the counter.

The above implementations are described for processing an SIP REGISTER service request. Nevertheless, there is no limitation on the type of the service request that can be processed. By way of example, the method applies equally well to an SIP INVITE service request. Under such circumstances, the processing method performed is equivalent to that performed for processing an SIP REGISTER request, with only the types of messages exchanged between the interrogation server 20 and the subscriber server 30 differing. Instead of using UAR and UAA messages, the servers exchange respectively location info request (LIR) and location info answer (LIA) messages. A counter for these subscriber server interrogations is then incremented in the first implementation, during step E8 each time an LIR request is sent including a request for capabilities, or in the second implementation during the step E8b each time an LIR request is received.

In another implementation, instead of a counter associated with a particular type of request (UAR or LIR in the above-described implementations), it may be advantageous to use a global counter that is incremented both when sending a UAR request or an LIR request, each of which includes a request for capabilities, with the counter being managed by the interrogation server 20 as described above for the first implementation, and also on receiving these requests without any explicit request for capabilities, with the counter being managed by the subscriber server 30, as described above for the second implementation. Taking account of all of the requests that give rise to a UAR or an LIR message being sent makes it possible in particular to start the optimization stage P2 more quickly.

Likewise, in another implementation, a plurality of thresholds are used for starting the second stage P2. By way of example, a threshold is associated with each counter defined by type of request. This makes it possible to adopt service restoration strategies of greater fineness, e.g. with a plurality of threshold values as a function of incoming traffic or indeed as a function of times of day. By way of example, the network operator may choose to perform the second stage P2 more quickly during times when network traffic is high.

FIG. 2 shows an interrogation server 20 arranged to process a service request relating to a user. It comprises in particular:
a first transceiver module 200 arranged to receive a service request relating to a user and to transfer it to a registration server;
a second transceiver module 202 arranged to interrogate a subscriber server in order to obtain in response an identifier of a registration server associated with the user or the capabilities that a registration server needs to possess in order to be capable of delivering the services that are authorized for a user;
a selector module 204 arranged to determine a replacement registration server on the basis of the received capabilities; and
a control module 206 arranged to control interrogation of the subscriber server.

In a first stage, the control module 206 is arranged to interrogate the subscriber server in order to obtain an identifier of a nominal registration server associated with the user, and after a failure to transfer the service request to the identified nominal registration server, to interrogate the subscriber server in order to obtain capabilities. In a second stage, as started once the nominal registration server is considered to be unreachable, the control module 206 is arranged to control a single transfer of the service request relating to a user to a registration server.

In the first implementation, the interrogation server 20 also includes a calculation module 208 arranged to update at least one counter relating to a reachability status of a registration server. The calculation module 208 determines that the nominal registration server is considered to be unreachable and starts the second stage P2.

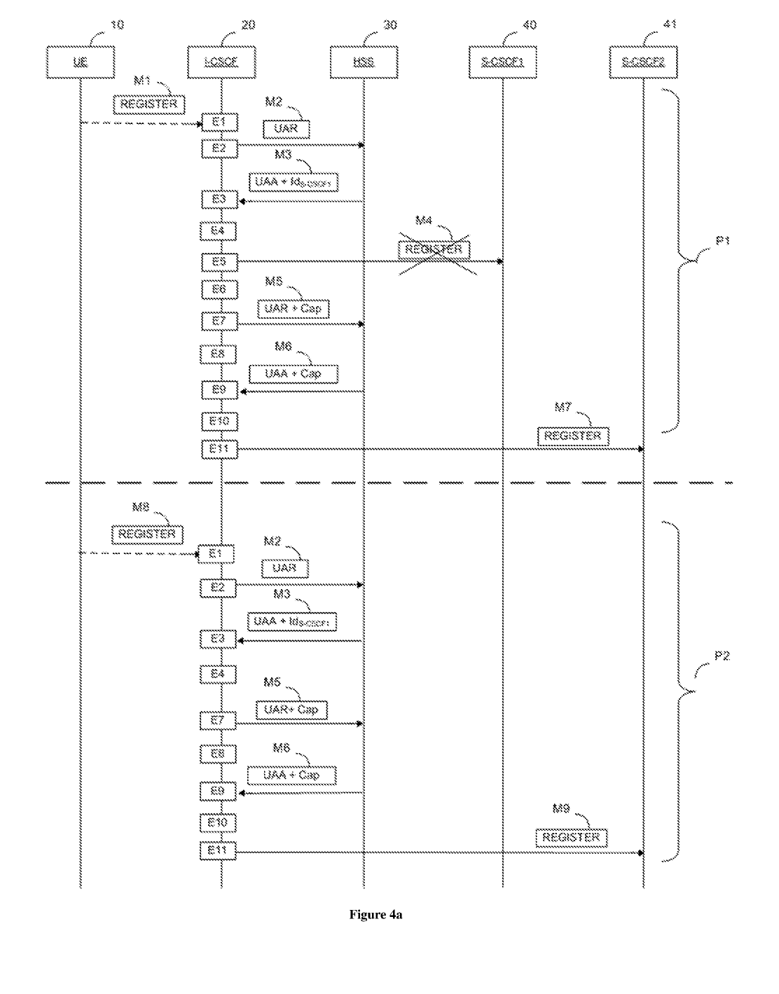

FIG. 3 shows a subscriber server 40 arranged to process a service request relating to a user. It comprises in particular:
a transceiver module 300 arranged to respond to an interrogation by an interrogation server, in particular in order to supply it with an identifier of a registration server associated with the user or in order to provide it with the capabilities that a registration server needs to possess in order to be capable of delivering the services that are authorized for a user; and
a control module 302 arranged to control the response to the interrogation server.

In the second embodiment, the subscriber server 30 further includes a calculation module 304 arranged to update at least one counter relating to a reachability status of a registration server.

In the second stage, started on the calculation module 304 detecting that the nominal registration server should be considered as being unreachable, the control module 302 is arranged to cause capabilities to be supplied directly in response to a request for a nominal registration server identifier, corresponding to the registration server that is considered to be unreachable.

The invention is performed by software and/or hardware components. In this context, the term “module” may correspond in this document equally well to a software component or to a hardware component or to a set of hardware and/or software components, suitable for performing a function or a set of functions, in the manner described above for the module in question.

A software component corresponds to one or more computer programs, one or more subprograms of a program, or in more general manner any element of a program or of software. Such a software component is stored in memory and then loaded and executed by a data processor of a physical entity and it is capable of accessing the hardware resources of that physical entity (memories, storage media, communication bus, electronic input/output cards, user interfaces, etc.).

In the same manner, a hardware component comprises any element of a set of hardware. It may comprise an optionally programmable hardware component, with or without an incorporated processor for executing the software. By way of example, it may be an integrated circuit, a smart card, an electronic card for executing firmware, etc.

In a particular embodiment, the modules 200, 202, 204, 206, and 208 are arranged to perform the above-described processing method. They are preferably software modules comprising software instructions for executing the steps of the above-described processing method as performed by an interrogation server. The invention thus also provides:
a program for an interrogation server, comprising program code instructions for controlling the execution of steps of the above-described processing method when said program is executed by said interrogation server; and
a data medium that is readable by an interrogation server and that stores the program for an interrogation server.

Likewise, the modules 300, 302, and 304 are arranged to perform the above-described processing methods. They are preferably software modules comprising software instructions for executing the steps of the above-described processing method when performed by a subscriber server. The invention thus also provides:
a program for a subscriber server, comprising program code instructions for controlling the execution of steps of the above-described processing method when said program is executed by said subscriber server; and
a data medium that is readable by a subscriber server and that stores the program for a subscriber server.

The software modules may be stored in or transmitted by a data medium. The data medium may be a hardware storage medium, e.g. a compact disk read only memory (CD ROM), a magnetic floppy disk or a hard disk, or indeed a transmission medium such as an electrical, optical, or radio signal, or a telecommunications network.

Although the present disclosure has been described with reference to one or more examples, workers skilled in the art will recognize that changes may be made in form and detail without departing from the scope of the disclosure and/or the appended claims.

1. A processing method to be performed in a communications network to process a service request relating to a user, said method comprising the following acts performed by an interrogation server during an optimization stage:
a/ receiving said service request relating to a user and coming from a user equipment;
b/ interrogating a subscriber server in order to obtain information enabling the service request to be processed;
c/ receiving capabilities that a registration server needs to possess in order to be capable of delivering the services authorized for said user, the capabilities being received from a subscriber server; and
d/ determining a replacement registration server on the basis of the received capabilities, and transferring the service request to the replacement registration server as determined;
wherein, during a detection stage during which a nominal registration server associated with said user is considered to be reachable, said method comprises said acts a/ to d/, and further comprises the following acts prior to the act c/ of receiving capabilities:
b1/ receiving an identifier of the nominal registration server in response to the interrogation of act b/;
b2/ transferring the service request to the nominal registration server; and in the event of a failure of making this transfer to the nominal registration server:
b3/ interrogating the subscriber server in order to obtain said capabilities;
and once the nominal registration server is considered to be unreachable at the end of the detection stage, starting the optimization stage, during which the transfer of act d/ is the sole transfer of the service request that is made to a registration server.

2. The processing method according to claim 1, further comprising an act of determining that the nominal registration server should be considered as being unreachable, which act is performed by the interrogation server.

3. The processing method according to claim 1, further comprising an act of determining that the nominal registration server should be considered as being unreachable, which act is performed by the subscriber server.

4. The processing method according to claim 1, wherein the unreachable status of the nominal registration server is determined using at least one counter associated with said nominal registration server that is updated during the detection stage in the event of a failure to transfer to the nominal registration server.

5. The processing method according to claim 4, wherein the unreachable status of the nominal registration server is determined on the basis of a plurality of counters respectively associated with a plurality of types of service request.

6. An interrogation server arranged to process a service request relating to a user, the server comprising:
a first transceiver module arranged to receive said service request relating to a user from a user equipment and to transfer it to a registration server;
a second transceiver module arranged to interrogate a subscriber server in order to obtain in return an identifier of a nominal registration server associated with the user, or to receive capabilities that a registration server needs to possess in order to be capable of delivering the services authorized for a user;
a selector module arranged to determine a replacement registration server on the basis of the received capabilities; and
a control module arranged to cause a subscriber server to be interrogated so that, during a first stage, an identifier is obtained for the nominal registration server associated with the user, a transfer is made to the nominal registration server, and in the event of a failure to transfer the service request to said nominal registration server, capabilities are obtained; and also arranged, during a second stage, to act, when the nominal registration server is considered to be unreachable, so as to make a single transfer of the service request relating to a user to a registration server,
wherein at least one of the first transceiver module, the second transceiver module, the selector module or the control module is implemented at least in part by a hardware component or a processor configured by a software component stored in a non-transitory computer-readable medium.

7. The interrogation server according to claim 2, further comprising a calculation module arranged to update at least one counter relating to an unreachability status of a registration server.

8. A subscriber server arranged to process a service request relating to a user, the server comprising:
a transceiver module arranged to respond to an interrogation from an interrogation server, to supply the interrogation server with an identifier of a nominal registration server associated with the user or to supply the interrogation server with capabilities that a registration server needs to possess in order to be able to deliver the services authorized for a user; and
a control module arranged to act during an optimization stage during which the nominal registration server is considered to be unreachable, to cause the capabilities to be supplied directly in response to a request for the identifier of said nominal registration server,
wherein at least one of the transceiver module or the control module is implemented at least in part by a hardware component or a processor configured by a software component stored in a non-transitory computer-readable medium.

9. The subscriber server according to claim 8, further comprising a calculation module arranged to update at least one counter relating to an unreachability status of a registration server.

10. A system for processing a service request in a communications network, said system comprising:
an interrogation server comprising:
a first transceiver module arranged to receive said service request relating to a user from a user equipment and to transfer it to a registration server;
a second transceiver module arranged to interrogate a subscriber server in order to obtain in return an identifier of a nominal registration server associated with the user, or to receive capabilities that a registration server needs to possess in order to be capable of delivering the services authorized for a user;
a selector module arranged to determine a replacement registration server on the basis of the received capabilities; and
a control module arranged to cause a subscriber server to be interrogated so that, during a first stage, an identifier is obtained for the nominal registration server associated with the user, a transfer is made to the nominal registration server, and in the event of a failure to transfer the service request to said nominal registration server, capabilities are obtained; and also arranged, during a second stage, to act, when the nominal registration server is considered to be unreachable, so as to make a single transfer of the service request relating to a user to a registration server;
a calculation module arranged to update at least one counter relating to an unreachability status of the nominal registration server; and
the subscriber server, comprising:
a transceiver module arranged to respond to the interrogation from the interrogation server, in particular to supply the interrogation server with the identifier of the nominal registration server associated with the user or to supply the interrogation server with the capabilities that a registration server needs to possess in order to be capable of delivering the services authorized for a user; and
a control module arranged to make the response to the interrogation server.

11. The system according to claim 10 for processing a service request, wherein the control module of the subscriber server is also arranged, during an optimization stage in which the nominal registration server is considered to be unreachable, to supply capabilities directly in response to a request for an identifier of said nominal registration server.

12. (canceled)

13. (canceled)

14. A non-transitory computer-readable medium having stored thereon a computer program including a series of program code instructions for allowing an interrogation server to execute steps of a method performed in a communications network to process a service request relating to a user, when said program is executed in a computer of the interrogation server, wherein the instructions configure the interrogation server to perform, during an optimization stage, acts of:
a/ receiving said service request relating to a user and coming from a user equipment;
b/ interrogating a subscriber server in order to obtain information enabling the service request to be processed;
c/ receiving capabilities that a registration server needs to possess in order to be capable of delivering the services authorized for said user, the capabilities being received from a subscriber server; and
d/ determining a replacement registration server on the basis of the received capabilities, and transferring the service request to the replacement registration server as determined;
wherein, during a detection stage during which a nominal registration server associated with said user is considered to be reachable, said method comprises said acts a/ to d/, and further comprises the following acts prior to the act c/ of receiving capabilities:
b1/ receiving an identifier of the nominal registration server in response to the interrogation of act b/;
b2/ transferring the service request to the nominal registration server; and in the event of a failure of making this transfer to the nominal registration server:
b3/ interrogating the subscriber server in order to obtain said capabilities;
and once the nominal registration server is considered to be unreachable at the end of the detection stage, starting the optimization stage, during which the transfer of act d/ is the sole transfer of the service request that is made to a registration server.

15. A non-transitory computer-readable medium having stored thereon a computer program including a series of program code instructions for allowing a subscriber server to process a service request relating to a user, when said program is executed in a computer of the subscriber server, wherein the instructions configure the subscriber server to perform acts of:
responding to an interrogation from an interrogation server, to supply the interrogation server with an identifier of a nominal registration server associated with the user or to supply the interrogation server with capabilities that a registration server needs to possess in order to be able to deliver the services authorized for a user; and
during an optimization stage during which the nominal registration server is considered to be unreachable, supplying directly the capabilities in response to a request for the identifier of said nominal registration server.
